(19) United States
(12) Patent Application Publication
(10) Pub. No.: US 2009/0065431 A1
(43) Pub. Date: Mar. 12, 2009

(54) IN-LINE SEPARATOR

(76) Inventors: Knut Bakke, Tananger (NO); Davoud Tayebi, Tananger (NO)

Correspondence Address: SHELL OIL COMPANY, P O BOX 2463, HOUSTON, TX, 772522463, US

(21) Appl. No.: 12/279,802

(22) PCT Filed: Feb. 19, 2007
(86) PCT No.: PCT/EP2007/051542

§ 371 Date: Aug. 18, 2008

(30) Foreign Application Priority Data
Feb. 20, 2006 (EP) 06110166.3

(51) Int. Cl. B01D 21/26

(52) U.S. Cl. 210/512.1

(57) ABSTRACT

An in-line separator is provided for separating fluid phases of different density from a fluid stream. The in-line separator comprises a conduit having an inlet section (2) for receiving the fluid stream, an outlet section (12) for separately transporting the fluid phases, and a swirl section (4) for inducing a swirling motion to the fluid stream as the stream flows from the inlet section (2) to the outlet section (12), the swirl section having an interior space (19a). At least a portion of said interior space forms a passageway (19a) for passage of tools from the inlet section (2) to the outlet section (12).

The present invention relates to an in-line separator for separating fluid phases of different density from a fluid stream.

Separation of fluid phases of different densities from a fluid stream is of interest for various industrial applications, such as the production of hydrocarbon fluid from a subsurface reservoir, the food industry, the pharmaceutical industry, and the process industry in general. In the production of oil or gas from a wellbore extending into a subterranean hydrocarbon fluid reservoir, usually some water is produced simultaneously with the hydrocarbon flow. The produced water may include, for example, formation water, injected water, condensed injected steam, solids from the formation, and chemicals/waste chemicals added downhole or during the oil/water separation process. Various techniques have been developed to separate the water downhole or at surface. Separating the produced water from the hydrocarbon fluid stream decreases the risk of surface pollution, reduces the need for water treatment and flow assurance, and reduces the hydrostatic pressure in the production line. The separated water can be injected into another formation, usually deeper than the producing formation, while the produced oil and/or gas are transported to the surface. Alternatively the separated water can be transported to the surface via a conduit extending through the wellbore, whereafter the water is treated in a dedicated treatment facility. Such water treatment facility can be placed at a location remote from the hydrocarbon processing facility. The treated water can be re-injected into the reservoir if desired.

A review of downhole separation technology is presented in SPE paper 94276. The paper describes different systems for downhole separation of produced water from the hydrocarbon fluid stream. In gravity separation systems the oil is allowed to rise upward due to density differences with the produced water. These systems require sufficient wellbore volume to provide an appropriate residence time for the oil particles to separate and rise from the fluid stream. In membrane systems a polymeric membrane is applied which is permeable to one or more components of the mixture and is impermeable to the remaining components. Since different wells operate at different downhole pressure regimes, it is expected that different membrane types are needed to allow for the capillary entry pressures of water that are experienced. In hydrocyclone separation systems the produced fluid mixture is introduced into the top cylindrical portion of a hydrocyclone and is induced to a swirling motion. The swirling of the mixture induces the water to spin to the outside of the hydrocyclone and move toward the lower outlet while the lighter fluids (oil and gas) remain in the center of the hydrocyclone where they are drawn through a vortex finder into the upper outlet.

A specific type of cyclone separator is an in-line separator which is generally formed as an integral part of a pipeline or tube through which the fluid mixture is transported. The in-line separator aims to separate the different fluid phases as the mixture flows through the pipeline or tube.

EP-1600215-A discloses an in-line separator incorporated in a pipeline, the separator comprising a tube in which a central body is arranged provided with vanes for imparting a swirling motion to a fluid mixture flowing through the tube. A conical section of the central body has helical slots or perforations through which the lighter phase flows to enter an inner passage of the in-line separator.

In U.S. Pat. No. 4,834,887 an in-line separator is described in which in the passage way in the outlet comprises a light phase outlet pipe. This outlet pipe blocks the pathway for tools.

In U.S. Pat. No. 4,654,061 an in-line separator is described in which the swirling zone is blocked by a swirling inducer. This inducer blocks the free passageway required for tools.

It has been found that the known in-line separator is impractical for certain applications, for example if limited space is available, or if tools for maintenance or repair purposes need to be transported through the pipeline. Examples of such tools are Pipeline Insert Gauges for cleaning of the inner surface of the pipeline or for inspection of the pipeline wall, and tools for measurement of temperature, pressure or flow.

It is therefore an object of the invention to provide an improved in-line separator which overcomes the problems of the prior art.

In accordance with the invention there is provided an in-line separator for separating fluid phases of different density from a fluid stream, the in-line separator comprising a conduit having an inlet section for receiving the fluid stream, an outlet section for transporting the separated fluid phases, and a swirl section for inducing a swirling motion to the fluid stream as the stream flows from the inlet section to the outlet section, wherein the swirl section has an interior space, and wherein at least a portion of said interior space forms a passageway for passage of tools from the inlet section to the outlet section.

The expression “fluid phases” is meant to refer to compositions having fluidic properties, such as gases, liquids, slurries containing solid particles, and mixtures of such compositions. The present invention especially concerns liquid/liquid separation, preferably oil/water separating.

With the in-line separator of the invention it is achieved that dedicated tools, for example for inspection, measurement or maintenance purposes, can pass unhampered through the swirl section of the in-line separator via said passageway. Furthermore, the passageway forms an open channel for the fluid stream. In a preferred embodiment the supply and discharge pipes, the inlet and outlet sections and the swirl zone all have the same diameters so as to ensure that a tool can pass through the separation device without any obstruction. It is observed that the diameter of the parts of the in-line separator may be larger than the diameter of the supply and discharge pipe. In another embodiment the diameter of the inlet section, the outlet section and the swirl zone are each 80% of the diameter, preferably 90% of the diameter of the supply pipe. The passageway is an open and free passageway, i.e. not blocked by any internal structures.

The inlet section, the swirl section and the outlet section can be formed separately or integrally, and in overlapping and non-overlapping manner. Furthermore, the inlet section and/or the outlet section can be integrally formed with respective portions of the pipeline in which the separator is incorporated. In order to create the free passageway for tools, the swirl section comprises swirl inducers that are located at the outer side of the section. Thus a free passageway for tools is obtained. This is an important difference with the prior art, where the swirl inducers are often in the center.

Suitably said interior space of the swirl section is of helical shape. For example, the swirl section of the conduit can be shaped in a helix, or a helically shaped insert such as a swirl flow guide can be arranged in a tubular portion of the conduit. With the inner surface of the swirl section being helically shaped, it is achieved that a swirling motion is gradually induced to the fluid stream without causing foaming or emulsifying due to abrupt velocity changes. The helical shape can be uniformly helical or progressively helical i.e. helical with varying pitch, especially a decreasing pitch in the flow stream direction.

The helical shape of the swirl section allows the in-line separator to be designed with an open central passageway of substantially uniform cross-sectional size along its length. Thus, the passageway for tools can have an internal diameter substantially equal to the internal diameter of the pipeline (or tube) in which the in-line separator is incorporated thereby enabling unobstructed passage of tools for inspection, measurement, maintenance or repair jobs through the pipeline and in-line separator.

Preferably the passageway has a central longitudinal axis extending substantially straight from the inlet section to the outlet section. The central longitudinal axis preferably coincides with the longitudinal axis of the supply and discharge pipe.

Furthermore, the passageway can be of substantially uniform cross-sectional size along the length thereof, or can have a decreasing cross-sectional size in the direction from the inlet section to the outlet section. Preferably the minimum diameter is at least the diameter of the supply and discharge pipe.

The in-line separator of the invention is attractive for a wide variety of applications including downhole wellbore applications mentioned above, subsea and topside applications such as bulk oil, water or gas separation, subsea processing, flow assurance, water separation, water treatment, and improving and/or upgrading of existing production facilities. The in-line separator can be used, for example, for liquid-liquid separation, liquid-gas separation, liquid-solids separation, gas-solids separation, and separation of one or more fluids and solids phases of different densities. Examples of such applications are found in the oil and gas industry, the food industry, the pharmaceutical industry, and the process industry in general.

The invention will be described hereinafter in more detail by way of example, with reference to the accompanying drawings in which:

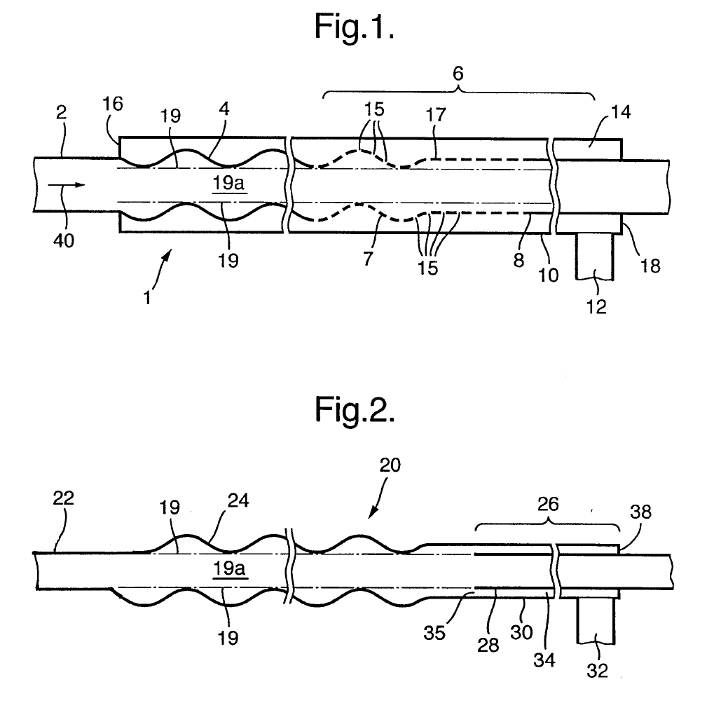

FIG. 1 schematically shows a longitudinal section of a first embodiment of an in-line separator according to the invention;

FIG. 2 schematically shows a longitudinal section of a second embodiment of an in-line separator according to the invention;

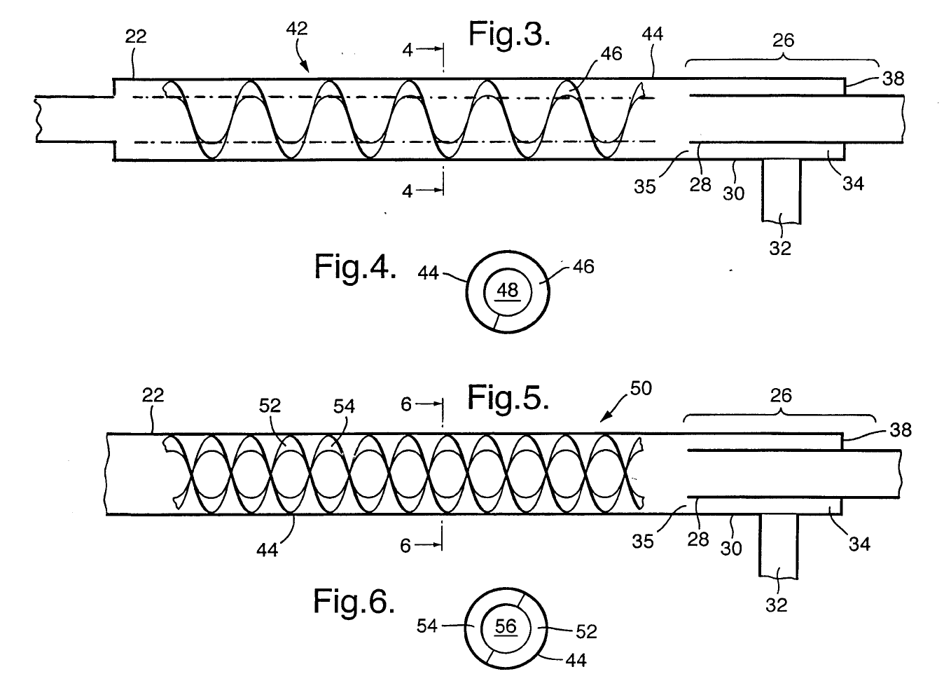

FIG. 3 schematically shows a longitudinal section of a third embodiment of an in-line separator according to the invention;

FIG. 4 schematically shows cross-section 4-4 of FIG. 3;

FIG. 5 schematically shows a longitudinal section of a fourth embodiment of an in-line separator according to the invention;

FIG. 6 schematically shows cross-section 6-6 of FIG. 5;

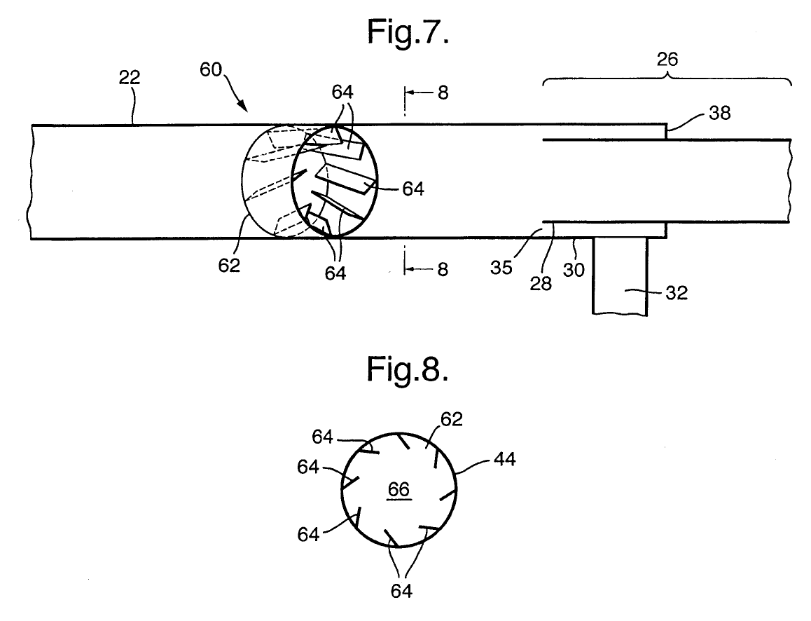

FIG. 7 schematically shows a longitudinal section of a fifth embodiment of an in-line separator according to the invention; and

FIG. 8 schematically shows cross-section 8-8 of FIG. 7.

In the figures, like reference numerals indicate like components.

Referring to FIG. 1 there is shown an in-line separator 1 incorporated in a production tubing extending into a wellbore (not shown) for the production of hydrocarbon fluid. The in-line separator 1 comprises an inlet tube 2 (or supply pipe) for receiving a stream of multiphase fluid of oil/gas and water or any other incoming multiphase flow, a swirl tube 4 of helical shape, or a tubular conduit provided with a helically shaped insert, for inducing a swirling motion to the multiphase fluid stream.

An extraction section 6 is provided for extracting the relatively heavy phase, i.e. water from, the multiphase fluid stream. The extraction section 6 includes a helical tube section 7 formed as a continuation of the swirl tube 4, a straight inner tube 8 connected to the helical tube section 7, a straight outer tube 10 substantially concentrically arranged around the inner tube 8, and a discharge tube 12 extending from the outer tube 10 and being in fluid communication with an annular space 14 formed between the inner tube 8 and the outer tube 10. The length of tubes 8 and 10 may vary depending on the location of the discharge tube 12. The swirl tube 4 is at one end thereof connected to the inlet tube 2 and at the other end to the helical tube section 7. Further, the inlet tube 2 and the inner tube 8 are integrally connected to the production tubing at opposite sides of the in-line separator 1.

The helical tube section 7 and a short length of the straight inner tube 8 are provided with an array of through-openings 15 which provide fluid communication between the interior of the swirl tube 4 and the annular space 14. End plates 16, 18 are provided at opposite ends of the outer tube 10 to close the annular space 14. The assembly of the inlet tube 2, the helical swirl tube 4, the helical tube section 7, and the inner tube 8 forms a continuous tubular conduit of substantially uniform internal diameter along the length thereof. The fraction of the extracted heavy phase (i.e. water) can be controlled by controlling the pressure on the discharge tube 12, for example by means of a choke (not shown) incorporated in the discharge tube 12.

In FIG. 2 is shown an in-line separator 20 comprising an inlet tube 22 for receiving a stream of multiphase fluid of hydrocarbon fluid and water produced from a well (not shown) or any other incoming multiphase flow, a swirl tube 24 of helical shape or a tubular conduit provided with a helically shaped insert for inducing a swirling motion to the fluid mixture.

An extraction section 26 is provided for extracting a stream of separated heavy phase (i.e. water) from the multiphase fluid stream. The extraction section 26 includes a straight inner tube 28, a straight outer tube 30 substantially concentrically arranged around the inner tube 28 (which outside the separator is the discharge pipe), and a discharge tube 32 extending from the outer tube 30 and being in fluid communication with an annular space 34 formed between the inner tube 28 and the outer tube 30. The length of tubes 28 and 30 may vary depending on the location of the discharge tube 32. The swirl tube 24 is at one end thereof connected to the inlet tube 22 and at the other end to the outer tube 30. Further, the inlet tube 22 and the inner tube 28 are integrally connected to the production tubing at opposite sides of the in-line separator 20.

One end 35 of the annular space 34 is open to the interior of the swirl tube 24, and the other end of the annular space 34 is closed by an end plate 38. The assembly of the inlet tube 22, the helical swirl tube 24, and the inner tube 28 forms a continuous flow passage of substantially uniform internal diameter along the length thereof. Similarly to the embodiment of FIG. 1, the fraction of the extracted heavy phase (i.e. water) can be controlled by controlling the pressure on the discharge tube 32. This can be achieved by means of a choke (not shown) incorporated in the discharge tube 32.

Dotted lines 19 are shown to indicate a central open portion of the interior space of the swirl tube 4, 24 defining a passageway 19a for tools that are required to pass through the production tubing and hence also through the in-line separator 1, 20.

In FIGS. 3 and 4 is shown an in-line separator 42 that is largely similar to the in-line separator 20 of FIG. 2 except that, instead of the swirl section being formed by a helical swirl tube, the swirl section is formed by a tubular element 44 that is internally provided with a helical vane (or coil) 46 connected to the inner surface of the tubular element 44. As shown in FIG. 4, a central portion of the interior space of the tubular element 44 defines an open passageway 48 for a fluid stream and for tools.

In FIGS. 5 and 6 is shown an in-line separator 50 that is largely similar to the in-line separator 42 of FIGS. 3 and 4, except that, instead of the tubular element 44 being provided with one helical vane, the tubular element 44 is internally provided with two helical vanes (or coils) 52, 54 connected to the inner surface of the tubular element 44. The helical vanes 52, 54 are staggeredly arranged relative to each other. If desired, more than two vanes can be applied in corresponding manner. As shown in FIG. 6, a central portion of the interior space of the tubular element 44 defines an open passageway 56 for a fluid stream and for tools.

In FIGS. 7 and 8 is shown an in-line separator 60 largely similar to the in-line separator 42, 50 of FIGS. 3-6, except that, instead of the tubular element 44 being provided with one or more helical vanes, the tubular element 44 is internally provided with a ring 62 having attached thereto a plurality of short vanes 64 extending inclined relative to a central longitudinal axis 59 of the in-line separator 60. If desired, more than one said ring 62 can be arranged in the tubular element 44. For example a plurality of said rings 62 can be arranged at regular mutual spacing in the tubular element 44. As shown in FIG. 8, a central portion of the interior space of the tubular element 44 defines an open passageway 66 for a fluid stream and for tools.

During normal use of the in-line separator 1 of FIG. 1, the in-line separator 1 is oriented vertically in the wellbore and a stream of multiphase fluid of water and hydrocarbon oil and/or gas produced from the well flows upwardly through the production tubing thereby passing into the inlet tube 2 in a direction indicated by arrow 40. The stream flows subsequently into the swirl tube 4. Due to the helical shape of swirl tube 4, the fluid stream is set to a swirling motion thereby subjecting the fluid stream to centrifugal forces. Due to the centrifugal forces, the relatively heavy water phase moves radially outward while the relatively light oil and/or gas phase moves toward the core region of the conduit. This phenomenon results in the separation of the fluid phases whereby the water phase flows along the inner surface of the swirl tube 4 and the oil and/or gas phase flows in the core region of the swirl tube 4. As the fluid stream enters the helical tube section 7, the centrifugal forces induce the water to flow via the through-openings 15 into the annular space 14. From there the water is discharged via discharge tube12. The separated water either can be injected into another formation usually deeper than the producing formation, or it can be transported to surface where the water is treated in a dedicated treatment facility. Such water treatment facility can be placed at a location remote from the hydrocarbon processing facility. The treated water can be re-injected into the reservoir if required. The separated stream of oil and/or gas continues flowing through the inner tube 8 and thence further through the production tubing to surface

Normal use of the in-line separator 20 shown in FIG. 2 is substantially similar to normal use of the in-line separator of FIG. 1, the main difference being that the water phase in the swirling stream enters the annular space 34 between the inner tube 28 and the outer tube 30 via the open end 35 of the annular space.

Normal use of the in-line separator 42, 50, 60 of respective FIGS. 3-8 is substantially similar to normal use of the in-line separator 20 of FIG. 2.

A significant advantage of the in-line separator of the invention is that the swirl section has an open passageway thus allowing tools to be moved through the pipeline and the in-line separator in an unobstructed manner. Preferably, the rotating motion of the fluid stream starts gradually, i.e. without abrupt velocity changes, due to the helical shape of the swirl tube or the vanes and the small, or gradually increasing, helix angle thereof. Furthermore, the residence time of the fluid stream in the swirl section is relatively long by virtue of its long and slender shape, thus providing sufficient time for the water phase to move to the outer region of the swirl section and for the oil and/or gas phase to move to the core region thereof. The relatively long residence time also allows coalescence of the separated phases to occur thereby enhancing the separation efficiency. Another advantage of the in-line separator relates to the substantially uniform diameter of the continuous flow passage formed by the assembly of inlet tube, swirl tube, and inner tube of the extraction section. As there is substantially no reduction in internal diameter of the production tubing, tools that may need to be lowered through the production tubing for conducting maintenance, measurement, monitoring or repair jobs can pass through the in-line separator in unobstructed manner. Furthermore, contrary to conventional swirl separators, virtually no foaming or emulsifying of the fluid phases occurs as the fluid passes through the in-line separator due to the gradually induced rotating motion of the fluid stream.

The in-line separator of the invention can also be used for separation of solid particles from liquid or gas, separation of liquid from gas, or for separation of a relatively heavy liquid component from a relatively light liquid component. More generally, the in-line separator can be used in any separation process whereby a fluidic component of relatively high density is separated from a fluidic component of relatively low density.

In a suitable embodiment, the in-line separator of the invention is arranged subsea at the lower end of an offshore riser for the production of hydrocarbon fluid from an earth formation, whereby the incoming multiphase fluid contains water. In a distributed subsea development, oil production from several sites is gathered in a common production flow line. The arrangement of the in-line separator at the lower end of the large vertical riser enables a lower pressure drop to occur in the riser if the water is removed and produced to a different pressure.

Instead of using the swirl tube of helical shape described hereinbefore, the swirl section can be formed of a tubular conduit provided with a helical swirl flow guide fixedly arranged in the tubular conduit.

Since the governing phenomena for separation of the phases is based on centrifugal forces caused by rotational movement, the in-line separator can be used and operated in any orientation such as horizontal, inclined or vertical. Likewise, in vertical and inclined orientation the incoming multiphase flow can enter the in-line separator from the top in a downward flowing direction, or from the bottom in an upward flowing direction.

1. An in-line separator for separating fluid phases of different density from a fluid stream, the in-line separator comprising a conduit having an inlet section for receiving the fluid stream, an outlet section for transporting the separated fluid phases, and a swirl section for inducing a swirling motion to the fluid stream as the stream flows from the inlet section to the outlet section, wherein the swirl section has an interior space, and wherein at least a portion of said interior space forms a passageway for passage of tools from the inlet section to the outlet section.

2. The in-line separator of claim 1, wherein said interior space of the swirl section is an open passageway, of helical shape.

3. The in-line separator of claim 2, wherein the passageway is formed by a central portion of said interior space of helical shape.

4. The in-line separator of claim 1, wherein the passageway has a central longitudinal axis extending substantially straight from the inlet section to the outlet section.

5. The in-line separator of claim 1, wherein the passageway is of substantially uniform cross-sectional size along the length thereof.

6. The in-line separator of claim 1, wherein the passageway has a decreasing cross-sectional size in the direction from the inlet section to the outlet section.

7. The in-line separator of claim 1, wherein the outlet section includes an outer tube and an inner tube extending substantially concentrically within the outer tube, and wherein the interior space of the inner tube forms a continuation of said passageway.

8. The in-line separator of claim 7, wherein an annular space between the inner tube and the outer tube is in fluid communication with an outlet for one said fluid phase of relatively high density, wherein the swirl section has a wall provided with a plurality of openings for discharging said fluid phase of relatively high density into the annular space.

9. (canceled)

10. (canceled)
